(19) United States
(12) Patent Application Publication
(10) Pub. No.: US 2024/0280404 A1
(43) Pub. Date: Aug. 22, 2024

(54) MONITORING SYSTEM, METHOD OF MONITORING AND STORAGE MEDIUM

(71) Applicant: NEC Corporation, Minato-ku, Tokyo (JP)

(72) Inventors: Murtuza PETLADWALA, Tokyo (JP); Tomoyuki HINO, Tokyo (JP)

(73) Assignee: NEC Corporation, Minato-ku, Tokyo (JP)

(21) Appl. No.: 18/571,377

(22) PCT Filed: Jun. 28, 2021
(86) PCT No.: PCT/JP2021/024273

§ 371 Date: Dec. 18, 2023

(51) Int. Cl. G01H 9/00; G01D 5/353

(52) U.S. Cl. CPC G01H 9/004; G01D 5/35361

(57) ABSTRACT

It is difficult to find corresponding between a point on an optical fiber and a point on a monitoring target, therefore, a monitoring system comprises an acquisition means for acquiring a plurality of amplitudes of vibrations for points on an optical fiber based on light propagating the optical fiber attached to a monitoring target, a generation means for generating a vibration mode of the monitoring target based on the plurality of amplitudes and a detection means for detecting a point on the monitoring target corresponding a point on the optical fiber based on the vibration mode.

### TECHNICAL FIELD

The present invention relates to a monitoring system or the like, in particular to correspond a point on an optical fiber cable and a point on a monitoring target.

### BACKGROUND ART

In recent year, the optical fiber sensing technology for acquiring environment information such as vibration and temperature around an optical fiber cable is developed. In the typical optical fiber sensing technology, a monitoring device transmit a pulse light in the optical fiber cable attached to a monitoring target such as bridge. The monitoring device acquire the environment information around the monitoring target by analyzing a backscattered light of the pulse light.

For example, patent Literature 1 (PTL1) disclose the optical fiber sensing technology for monitoring a structure by using the optical fiber cable attached to the structure.

### CITATION LIST

### Patent Literature

[PTL1] International Publication No 2020/213060

### SUMMARY OF INVENTION

### Technical Problem

On the typically optical fiber sensing technology, the monitoring device acquires environment and surrounding information between a point on an optical fiber cable and a point on a monitoring target, which is necessary for monitoring on a plurality of points in the monitoring target. On the other hand, finding corresponding between a point on an optical fiber cable and a point on a monitoring target is difficult.

An exemplary object of the invention is to provide a monitoring system or the like, in particular, to find corresponding between a point on an optical fiber cable and a point on a monitoring target.

### Solution to Problem

A monitoring system according to an exemplary aspect of the invention comprises;
an acquisition means for acquiring a plurality of amplitudes of vibrations for points on an optical fiber cable based on light propagating the optical fiber cable attached to a monitoring target;
a generation means for generating a vibration mode of the monitoring target based on the plurality of amplitudes; and
a detection means for detecting a point on the monitoring target corresponding a point on the optical fiber cable based on the vibration mode.

A monitoring method according to an exemplary aspect of the invention comprises;
acquiring a plurality of amplitudes of vibrations for points on an optical fiber cable based on light propagating the optical fiber cable attached to a monitoring target;
generating a vibration mode of the monitoring target based on the plurality of amplitudes; and
detecting a point on the monitoring target corresponding a point on the optical fiber cable based on the vibration mode.

A non-transitory computer-readable storage medium according to an exemplary aspect of the invention stores a program for causing a computer to execute:
acquiring a plurality of amplitudes of vibrations for points on an optical fiber cable based on light propagating the optical fiber cable attached to a monitoring target;
generating a vibration mode of the monitoring target based on the plurality of amplitudes; and
detecting a point on the monitoring target corresponding a point on the optical fiber cable based on the vibration mode.

### Advantageous Effects of Invention

An exemplary advantage according to the present invention is providing a monitoring system, a method of monitoring and a storage medium, in particular, to corresponding between a point on an optical fiber cable and a point on a monitoring target.

### BRIEF DESCRIPTION OF DRAWINGS

FIG. 1 is a block diagram illustrating configuration example of a monitoring system in accordance with a first example embodiment of the present invention.

FIG. 2 is a drawing for explaining the monitoring system in accordance with a first example embodiment of the present invention.

FIG. 3 is a drawing for explaining the monitoring system in accordance with a first example embodiment of the present invention.

FIG. 4 is a drawing for explaining the monitoring system in accordance with a first example embodiment of the present invention.

FIG. 5 is a flowchart for explaining an operation of the monitoring system in accordance with a first example embodiment of the present invention.

FIG. 6 is a drawing for explaining the monitoring system in accordance with a first example embodiment of the present invention.

FIG. 7 is a drawing for explaining the monitoring system in accordance with a first example embodiment of the present invention.

FIG. 8 is a block diagram illustrating configuration example of a monitoring device in accordance with a two example embodiment of the present invention.

FIG. 9 is a flowchart for explaining an operation of the monitoring device in accordance with a two example embodiment of the present invention.

### DESCRIPTION OF EMBODIMENTS

### First Example Embodiment

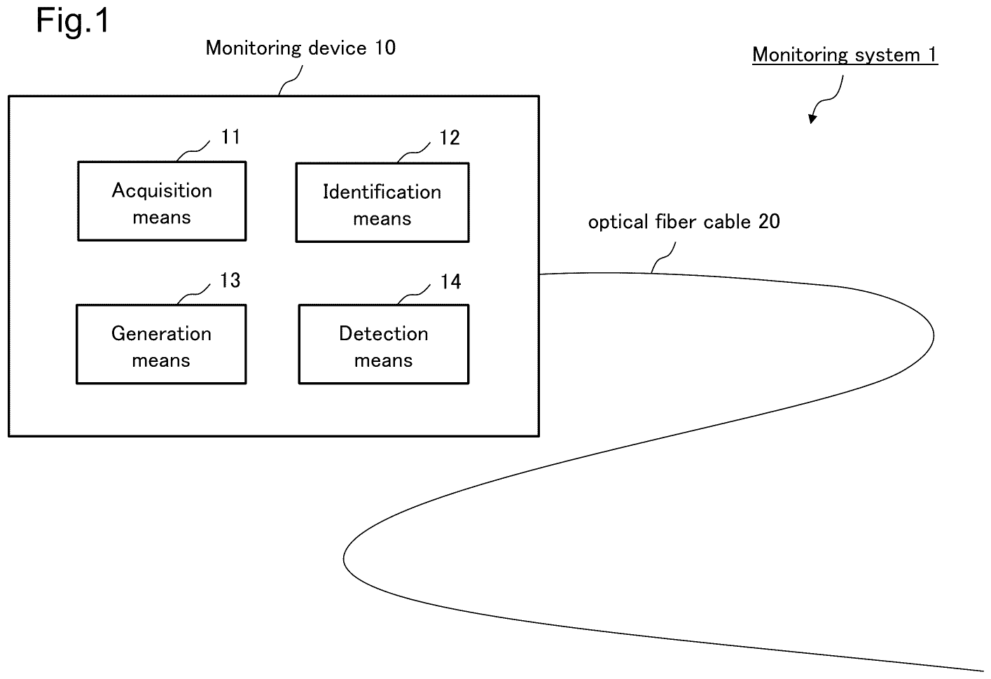

A monitoring system 1 is explained based on the FIG. 1. FIG. 1 is a block diagram illustrating a configuration example of the monitoring system 1. As shown in FIG. 1, the monitoring system 1 comprises a monitoring device 10 and an optical fiber cable 20. On the monitoring system 1, the monitoring device 10 monitors environment around the optical fiber cable 20 by using the optical fiber cable as a sensor. The optical fiber cable 20 is laid along the road on which the vehicles travel in the first example embodiment. A monitoring target described later is a bridge included in the road.

The monitoring device 10 comprises an acquisition means 11, an identification means 12, a generation means 13 and a detection means 14. The acquisition means 11, the identification means 12, the generation means 13 and the detection means 14 are also called a acquisitor, an identificator, a generator and a detector respectively. As shown in FIG. 1, the monitoring device 10 is connected with the optical fiber cable 20. The monitoring device 10 comprises a light source and a receiving means not shown. The light source outputs a pulse light to the optical fiber cable 20. The light source may repeatedly outputs the pulse light at predetermined intervals. In the optical fiber cable 20, Rayleigh back-scattering light is generated at a plurality of points on the optical fiber cable 20 by propagating the pulse light through the optical fiber cable 20. The receiving means receives the Rayleigh back-scattering light from the plurality of points on the optical fiber cable 20. The receiving means detects amplitudes of vibration on the plurality of points on the optical fiber cable 20 by analyzing the Rayleigh back-scattering light. For example, the receiving means detects the amplitudes of vibration on the plurality of points on the optical fiber cable 20 based on phase change of the Rayleigh back-scattering light. The receiving means outputs information indicating the amplitudes of vibration on the plurality of points on the optical fiber cable 20 to the acquisition means 11. The points on the optical fiber cable 20 indicates the points on a surface of the optical fiber cable 20.

The acquisition means 11 acquire the amplitudes of vibration on the plurality of points on the optical fiber cable 20 from the Rayleigh back-scattering light propagating in the optical fiber cable 20 attached to the monitoring target. The acquisition means 11 may include the light source and receiving means above-mentioned.

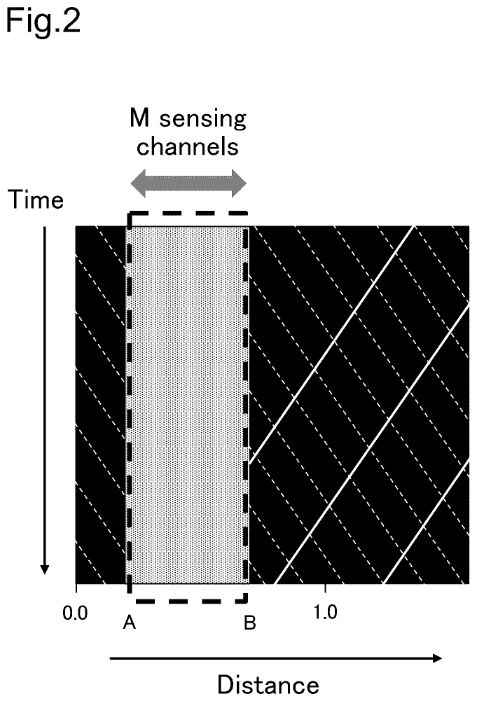

The acquisition means 11 may calculate sum of the plurality of amplitudes of vibration on each of intervals on the optical fiber cable 20. Specifically, the acquisition means 11 calculates a total of amplitudes acquired based on the Rayleigh back-scattering light from the points in a predetermined interval on the optical fiber cable 20 as the sum of amplitude on the predetermined interval on the optical fiber cable 20. The acquisition means 11 generates a first graph indicating a first correspondence relationship between the sums of the intervals and the intervals. The acquisition means 11 further acquire the amplitudes of vibration on the plurality of points on the optical fiber cable 20 over a plurality of times in a certain period. The acquisition means 11 generates a second graph as shown in FIG. 2 indicating a second correspondence relationship between each of the times and the first correspondence relationship.

The identification means 12 identifies a monitoring part corresponding the monitoring target based on the plurality of amplitudes of vibrations for points on the optical fiber cable 20. An operation of the identification means 12 is explained based on the FIG. 2.

FIG. 2 indicates the change of the amplitude of the vibration for each points on the optical fiber cable 20 over time, the amplitude acquired by the acquisition means 11. A vertical axis in FIG. 2 indicates time. A horizontal axis in FIG. 2 indicates the distance from the monitoring device 10. Intensity of the color in the FIG. 2 indicates the amplitude of the vibration. For example, an amplitude of a gray part is bigger than the amplitude of a black part.

A line extending from the upper right to the lower left in FIG. 2 indicates approaching of vehicle(s) to the monitoring device 10 over time. The colors in FIG. 2 indicates that vibration occurred in a part between a point A and a point B is always bigger than vibration occurred in other part. If the monitoring target is bridge, the vibration for the monitoring target is always bigger than the vibration for the road. Therefore, the identification means 12 identifies that the monitoring part is located in the part between a point A and a point B.

As above, the identification means 12 identifies the monitoring part corresponding the monitoring targets in the optical fiber cable 20 based on the amplitude of vibration for the points on the optical fiber cable 20. For example, the identification means 12 identifies that the part detected the vibration of the amplitude above the threshold during the predetermined period is the monitoring part. The M sensing channels in FIG. 2 indicates the different positions in the monitoring part. The identification means 12 may identify a plurality of the monitoring parts for the optical fiber cable 20. The identification means 12 may mask the part other than the monitoring part and output only information of the monitoring part to outside.

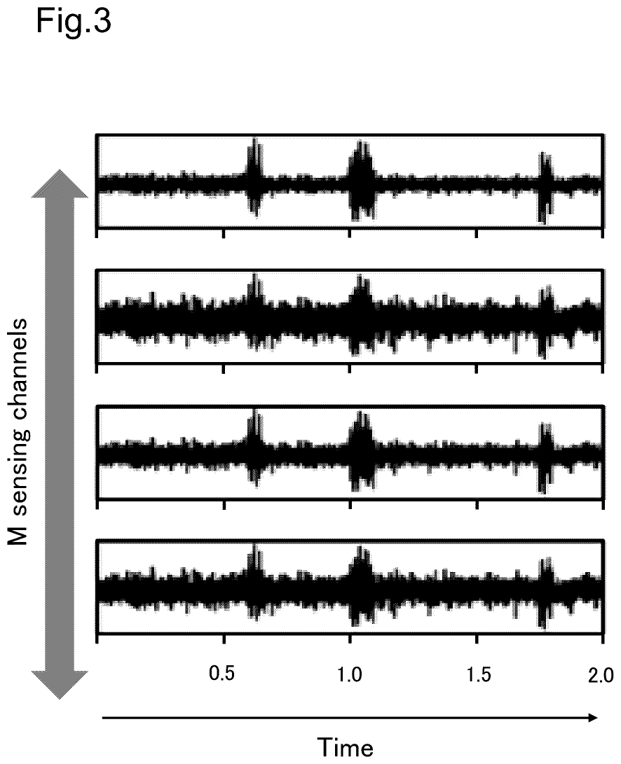

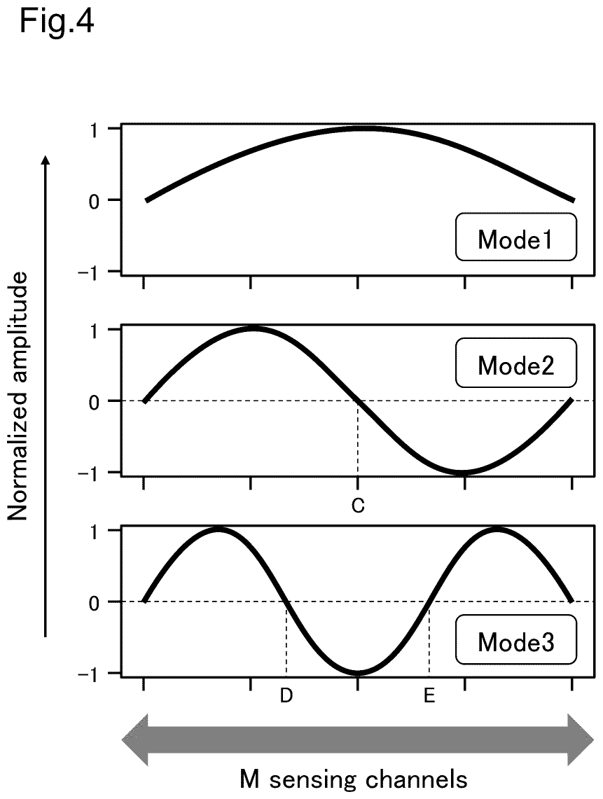

The generation means 13 generates a vibration mode of the monitoring target based on the plurality of amplitudes of the vibration for the monitoring part identified by the identification means 12. An operation of the generation means 13 is explained based on the FIG. 3 and FIG. 4. The generation means 13 generates the vibration mode for each of the monitoring targets, if the identification means 12 identified a plurality of the monitoring parts.

FIG. 3 indicates a change of the vibration detected based on the Rayleigh backscattered lights from the different positions in the monitoring part. The generation means 13 acquires information including the change of the vibration in a plurality of the points on optical fiber cable 20 from the acquisition means 11.

The generation means 13 generates the vibration modes of the monitoring target by analyzing the information including the change of the vibration as shown in the FIG. 2. Known methods is used for analyzing by the generation means 13. As an example, vibration modes may be extracted by standard peak picking methods in the frequency domain. As another example, Frequency Domain Decomposition (FDD) method maybe applied to fiber sensor vibration signals. Since, phase change in Rayleigh backscattering light are relative responses of the surrounding vibration, the vibration amplitudes possess different scale and offset at each sensing channel in the fiber cable. The vibration modes are global level information of the structure, so each sensing channels are standardize by the generation means 13, for example, to unit variance so that extracted vibration modes are closely related to theoretical vibration mode shapes of target bridge. The FDD technique extract vibration mode shapes by following steps:
1. Estimate spectral density matrices from the raw time series vibration.
2. Perform singular value decomposition of the spectral density matrices.
3. Pick dominant peaks on the average singular values.
4. Vibration mode corresponds to Eigen vector at selected peak singular frequency.

FIG. 4 indicates the vibration mode of the monitoring target. Specifically, Mode 1 in FIG. 4 indicates a primary vibration mode, Mode 2 indicates a secondary vibration mode and Mode 3 indicates a tertiary vibration mode. A vertical axis for each of the vibration modes in FIG. 4 indicates the amplitude of the vibration mode. A horizontal axis in FIG. 4 indicates the points on the optical fiber cable 20. In this example embodiment, the horizontal axis indicates the part between the point A and the point B, as shown in the FIG. 2. Therefore, the vibration modes in FIG. 4 indicates the vibration modes of the monitoring parts corresponding to the monitoring targets. In other words, FIG. 4 indicates the vibration modes of the monitoring target because the vibration of the monitoring part in the optical fiber cable 20 and the vibration of the monitoring target are same.

The detection means 14 detects at least one point on the monitoring target corresponding to the point on the optical fiber cable 20 based on the vibration mode. The point on the monitoring target indicates the points where a surface of the optical fiber cable 20 and the monitoring target meet. For example, the detection means 14 detects that the points which the amplitude is zero in the primary vibration modes is the edge of the monitoring target. The detection means 14 also detects that the point C which the amplitude is zero in the secondary vibration modes in FIG. 4 is the center of the monitoring target. The detection means 14 also detects that the point D which the amplitude is zero in the tertiary vibration modes in FIG. 4 is the one third point between edges of the monitoring target. The detection means 14 also detects that the point E which the amplitude is zero in the tertiary vibration modes in FIG. 4 is the two third point between edges of the monitoring target. As above, the detection means 14 detects N-1 points on the monitoring targets from the Nth vibration mode.

The detection means 14 may detect the other point on the monitoring target based on below method. The detection means 14 obtains the inverse sine function of the input mode shape Ψ_n(x) from equation (1).

$${θ}_{n} = {sin}^{- 1} ( {Ψ}_{n} ( x ) ) \qquad ( 1 )$$

The detection means 14 obtains weight coefficients by obtaining angle between (−π)/2 & π/2 angle and dividing by π/2, since inverse sine is multivalued. The detection means 14 obtains the rate of change between 2 consecutive points on the monitoring target by applying forward differential.

The detection means 14 obtains the absolute changes of weights from equation (2). In the equation (2), 1 is length of the monitoring part, which is assumed as value 1.

$${θ}_{n}^{x} = \frac{d ( \frac{2 l {θ}_{n}}{n π} )}{d x} \qquad ( 2 )$$

The detection means 14 obtains points on the monitoring target x(m) by cumulatively aggregating the absolute changes of weights by equation (3). In the equation (3), |·| is absolute function.

$$x ( m ) = {\sum }_{k = 0}^{m} \vert {θ}_{n}^{x} [ k ] \vert \qquad ( 3 )$$

The detection means 14 normalizes the cumulative aggregate between value 0 and 1 and obtains normalized the monitoring target location x in equation (4). Final output variable x will be value between 0 and 1, which represents the distance from the starting point of the monitoring part.

$$x = \frac{x ( m )}{max ( x ( m ) )} \qquad ( 4 )$$

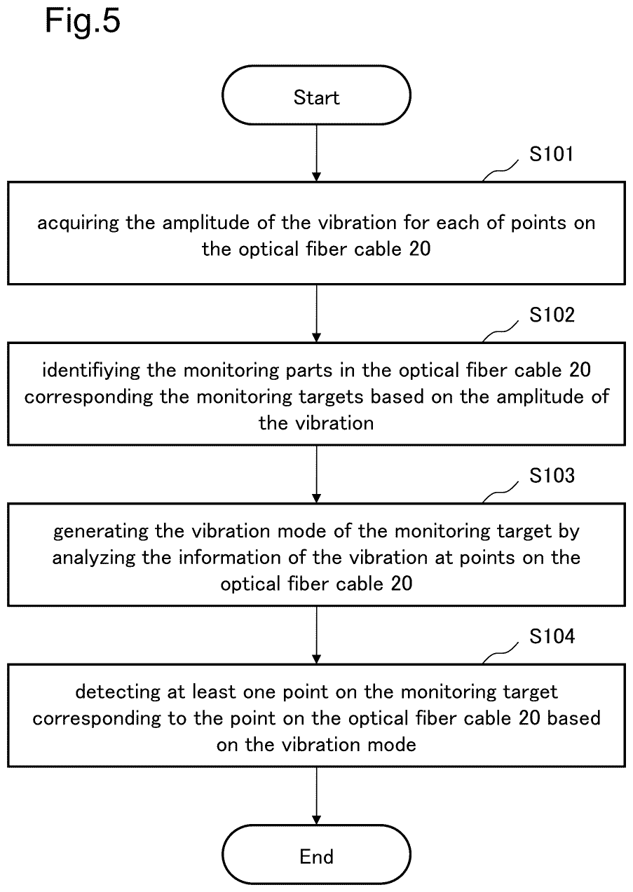

Next, it describes operation of the monitoring system 1 based on FIG. 5. The acquisition means 11 acquires the amplitude of the vibration for each of points on the optical fiber cable 20 (S101). For example, the amplitude of the vibration for each of points is derived based on phase change of the Rayleigh back-scattering light as mentioned above.

The identification means 12 identifies the monitoring parts in the optical fiber cable 20 corresponding the monitoring targets based on the amplitude of the vibration acquired by the acquisition means 11 (S102). For example, a part which attached to the bridge in the optical fiber cable 20 is the monitoring part, if the monitoring target is the bridge. The vibration for the monitoring part is bigger than the vibration for the part other than the monitoring part if the part other than the monitoring part in the optical fiber cable 20 is attached to the road. Therefore, the identification means 12 identifies the part where vibration with an amplitude above the threshold value continues to be detected as the monitoring part.

The generation means 13 generates the vibration mode of the monitoring target by analyzing the information of the vibration at points on the optical fiber cable 20 (S103). Known methods is used for analyzing by the generation means 13. The generation means 13 may generates the plurality of the vibration modes as shown in FIG. 4.

The detection means 14 detects at least one point on the monitoring target corresponding to the point on the optical fiber cable 20 based on the vibration mode (S104). For example, the detection means 14 detects the points corresponding the edge of the monitoring target, the center of the monitoring target, the one third point between edges of the monitoring target and the two third point between edges of the monitoring target.

As above mentioned, the monitoring system 1 comprises the acquisition means 11, the generation means 13 and the detection means 14. The acquisition means 11 acquires a plurality of amplitudes of vibrations for points on an optical fiber cable 20 based on light propagating the optical fiber cable 20 attached to a monitoring target. The generation means 13 generates a vibration mode of the monitoring target based on the plurality of amplitudes. The detection means 14 detects a point on the monitoring target corresponding a point on the optical fiber cable 20. Therefore, the monitoring system 1 can corresponds between a point on an optical fiber cable 20 and a point on a monitoring target.

For example, identifying the point on the optical fiber cable 20 corresponding the edge or center of the monitoring target is possible. Therefore, the monitoring system 1 measures accurately the vibration for the edge or center of the monitoring target.

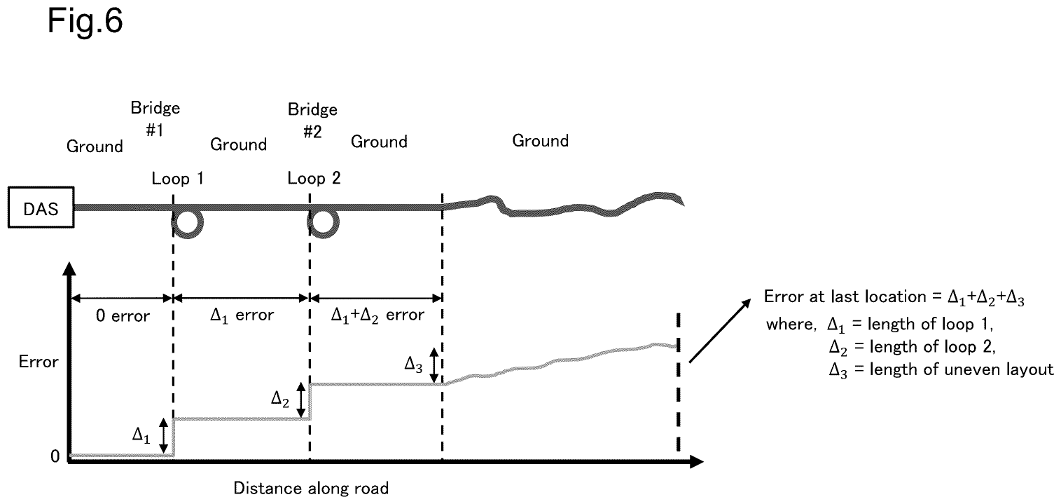

FIG. 6 indicates an error which is difference between a distance from a distributed acoustics sensor (DAS) to a position and a distance from DAS to a position on the road. A vertical axis in FIG. 6 indicates the error. A horizontal axis in FIG. 6 indicates the distance from a distance from DAS to a position on the road. The DAS corresponds the monitoring device 10 in this example embodiment. The error mentioned above is high when the optical fiber cable layout is loop-type. As shown in FIG. 6, the optical fiber cable is longer than the road. In the case the optical fiber cable is attached with uneven layout, the monitoring system 1 can measure accurately the vibration for the edge or center of the monitoring target because of corresponding between the point on an optical fiber cable and the point on a monitoring target based on the vibration mode of the monitoring target.

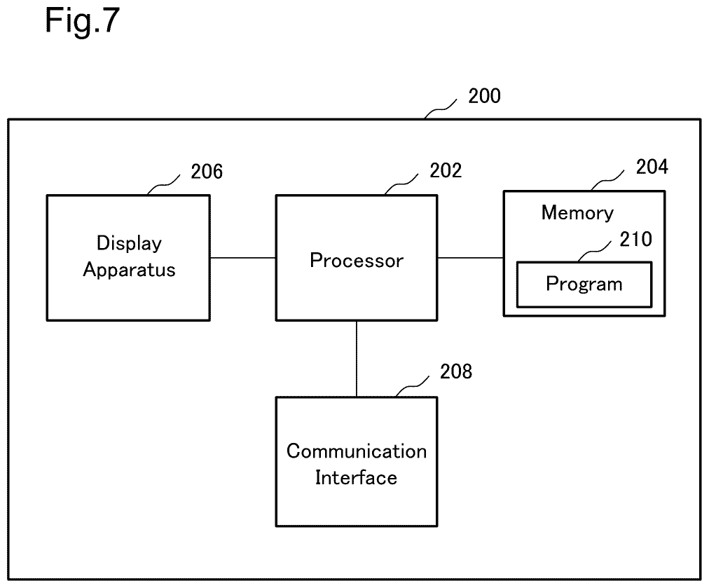

The monitoring device 10 may be implemented on a computer apparatus 200 as illustrated in FIG. 7. Referring to FIG. 7, the computer apparatus 200, such as a server, includes a processor (Central Processing Unit) 202, a memory 204 and so forth, a display apparatus 206 that display the result of calibration of the bridge-points, and a communication interface 208. The memory 204 includes, for example, a semiconductor memory (for example, Random Access Memory (RAM), Read Only Memory (ROM), Electrically Erasable and Programmable ROM (EEPROM), and/or a storage device including at least one of Hard Disk Drive (HDD), SSD (Solid State Drive), Compact Disc (CD), Digital Versatile Disc (DVD).

The communication interface 208 (such as a network interface controller (NIC)) may well be configured to communicatively connect to sensing device. A program 210 including program instructions (program modules) for executing processing of an acquisition means 11, an identification means 12, a generation means 13 and a detection means 14 is stored in a memory 204.

The processor 202 is configured to read the program 210 (program instructions) from the memory 204 to execute the program 210 (program instructions) to realize the function and processing of the monitoring system 1.

### Second Example Embodiment

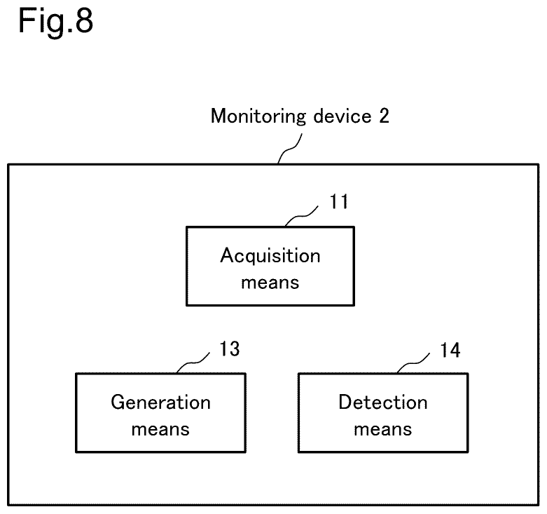

An optical monitoring device 2 on the second example embodiment is described based on FIG. 8. FIG. 8 is a block diagram illustrating a configuration example of the monitoring device 2. The monitoring device 2 comprises the acquisition means 11, the generation means 13 and the detection means 14. The monitoring device 2 may have a same configuration, same functions and a same connection relationship as the monitoring device 10 in the first example embodiment.

The acquisition means 11 acquires a plurality of amplitudes of vibrations for points on an optical fiber cable based on light propagating the optical fiber cable attached to a monitoring target. The acquisition means 11 may have a same configuration, same functions and a same connection relationship as the acquisition means 11 in the first example embodiment.

The generation means 13 generates a vibration mode of the monitoring target based on the plurality of amplitudes of vibrations for points on an optical fiber cable. The generation means 13 may have a same configuration, same functions and a same connection relationship as the generation means 13 in the first example embodiment.

The detection mean 14 detects a point on the monitoring target corresponding a point on the optical fiber cable based on the vibration mode. The detection mean 14 may have a same configuration, same functions and a same connection relationship as the detection mean 14 in the first example embodiment.

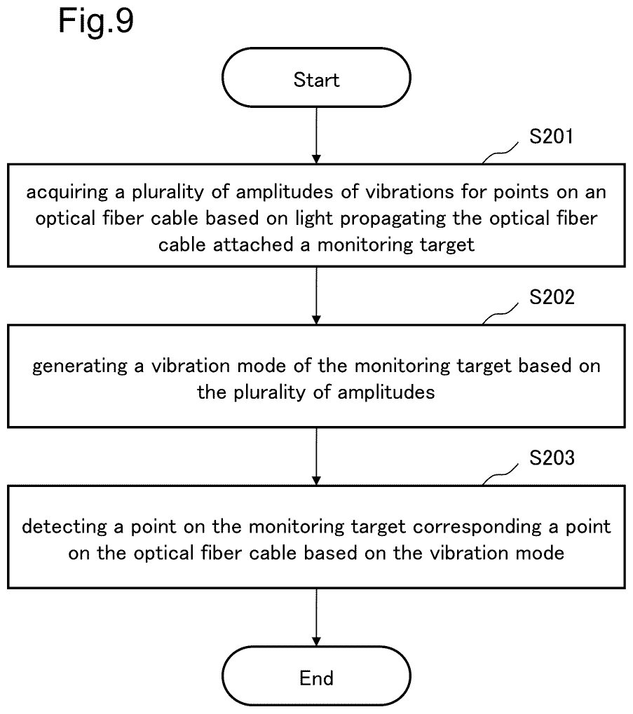

Next, it describes operation of the monitoring device 2 based on FIG. 9. FIG. 9 is a flowchart for explaining an operation of the monitoring device 2 in accordance with a second example embodiment of the present invention. The acquisition means 11 acquires a plurality of amplitudes of vibrations for points on an optical fiber cable based on light propagating the optical fiber cable attached to a monitoring target. (S201). The generation means 13 generates a vibration mode of the monitoring target based on the plurality of amplitudes of vibrations for points on an optical fiber cable (S202). The detection mean 14 detects a point on the monitoring target corresponding a point on the optical fiber cable based on the vibration mode (S203).

As above mentioned, the monitoring device 2 comprises the acquisition means 11, the generation means 13 and the detection means 14. Therefore, the monitoring device 2 can corresponds between a point on an optical fiber cable and a point on a monitoring target.

For example, identifying the point on the optical fiber cable corresponding the edge or center of the monitoring target is possible. Therefore, the monitoring device 2 measures accurately the vibration for the edge or center of the monitoring target.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A monitoring system comprising:
at least one memory configured to store instructions; and at least one processor configured to execute the instructions to
acquire a plurality of amplitudes of vibrations for points on an optical fiber cable based on light propagating the optical fiber cable attached to a monitoring target,
generate a vibration mode of the monitoring target based on the plurality of amplitudes, and
detect a point on the monitoring target corresponding a point on the optical fiber based on the vibration mode.

2. The monitoring system according to claim 1,
Wherein the at least one processor
calculates sum of the plurality of amplitudes on each of intervals on the optical fiber; and
generates a graph indicating a first correspondence relationship between the sums of the intervals and the intervals.

3. The monitoring system according to claim 1,
wherein the at least one processor,
acquires the plurality of amplitudes of vibrations over a plurality of times, and
generates a graph indicating a second correspondence relationship between each of the times and the first correspondence relationship.

4. The monitoring system according to claim 1, wherein the at least one processor
identifies a monitoring part corresponding the monitoring target based on the plurality of amplitudes of vibrations for points on the optical fiber, and
generates the vibration mode of the monitoring target based on the vibrations for points on the monitoring part.

5. The monitoring system according to claim 4,
Wherein the at least one processor
identifies monitoring parts corresponding the monitoring targets based on the plurality of amplitudes of vibrations for points on the optical fiber, and
standardizes the vibrations for points on the monitoring parts and generates the vibration modes of the monitoring targets based on the standardized vibrations for points on the monitoring parts.

6. The monitoring system according to claim 1,
wherein the at least one processor detects which a point of the vibration mode is a point of the monitoring target.

7. A monitoring method comprising:
acquiring a plurality of amplitudes of vibrations for points on an optical fiber based on light propagating the optical fiber attached to a monitoring target;
generating a vibration mode of the monitoring target based on the plurality of amplitudes; and
detecting a point on the monitoring target corresponding a point on the optical fiber based on the vibration mode.

8. A non-transitory computer-readable storage medium that stores a program for causing a computer to execute:
acquiring a plurality of amplitudes of vibrations for points on an optical fiber based on light propagating the optical fiber attached to a monitoring target;
generating a vibration mode of the monitoring target based on the plurality of amplitudes; and
detecting a point on the monitoring target corresponding a point on the optical fiber based on the vibration mode.

9. The monitoring system according to claim 2,
wherein the at least one processor
acquires the plurality of amplitudes of vibrations over a plurality of times, and
generates a graph indicating a second correspondence relationship between each of the times and the first correspondence relationship.

10. The monitoring system according to claim 2, wherein the at least one processor
identifies a monitoring part corresponding the monitoring target based on the plurality of amplitudes of vibrations for points on the optical fiber, and
generates the vibration mode of the monitoring target based on the vibrations for points on the monitoring part.

11. The monitoring system according to claim 3, wherein the at least one processor
identifies a monitoring part corresponding the monitoring target based on the plurality of amplitudes of vibrations for points on the optical fiber, and
generates the vibration mode of the monitoring target based on the vibrations for points on the monitoring part.

12. The monitoring system according to claim 10,
Wherein the at least one processor
identifies monitoring parts corresponding the monitoring targets based on the plurality of amplitudes of vibrations for points on the optical fiber, and
standardizes the vibrations for points on the monitoring parts and generates the vibration modes of the monitoring targets based on the standardized vibrations for points on the monitoring parts.

13. The monitoring system according to claim 11,
Wherein the at least one processor
identifies monitoring parts corresponding the monitoring targets based on the plurality of amplitudes of vibrations for points on the optical fiber, and
standardizes the vibrations for points on the monitoring parts and generates the vibration modes of the monitoring targets based on the standardized vibrations for points on the monitoring parts.

14. The monitoring system according to claim 2,
wherein the at least one processor detects which a point of the vibration mode is a point of the monitoring target.

15. The monitoring system according to claim 3,
wherein the at least one processor detects which a point of the vibration mode is a point of the monitoring target.

16. The monitoring system according to claim 4,
wherein the at least one processor detects which a point of the vibration mode is a point of the monitoring target.

17. The monitoring system according to claim 5,
wherein the at least one processor detects which a point of the vibration mode is a point of the monitoring target.
